(19) United States
(12) Patent Application Publication
(10) Pub. No.: US 2008/0208751 A1
(43) Pub. Date: Aug. 28, 2008

(54) Method, Apparatus and System for Providing Added Value Content to Feature Content End Users

(75) Inventor: Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/679,438

(22) Filed: Feb. 27, 2007

(51) Int. Cl. H04L 9/00

(52) U.S. Cl. 705/51

(57) ABSTRACT

A system, method and apparatus are provided for offering or providing added value content associated with feature content to feature content end users. The system includes a receiver that has a processor or controller for reading end user or feature content, such as a film or programming event. The feature content is broadcast or downloaded as an encoded video stream from a suitable source, such as a video server. Metadata associated with the feature content includes information about available added value content that is associated with the feature content. The method includes providing, based on reading the associated metadata, the ability for the end user to obtain added value content associated with the feature content that has been selected and/or obtained by the end user. The added value content can be obtained by the end user and packaged with the feature content and recorded on a suitable recording medium.

### BACKGROUND OF THE INVENTION

1. Field of the Invention

The invention relates to end user content, such as downloadable feature content. More particularly, the invention relates to providing added value content, associated with the feature content, to feature content end users.

2. Description of the Related Art

Content providers of feature content, such as feature films or special programming events, often package additional content or added value (extended) content with the feature content as a way of potentially increasing consumer sales of the feature content. For example, a movie studio or other provider of feature content may package the feature content with previously deleted scenes, additional commentary by the director and/or the cast, interviews of the cast, outtakes and/or behind the scenes footage as part of the digital video disc (DVD) release of the movie. The added value content often is intended to increase the value of the DVD, thus potentially increasing DVD sales.

The use of added value content to increase sales has become increasingly important as the number of distribution options for consumers or end users to view feature content continues to increase. Video recording devices, such as videocassette recorders (VCRs) and, more recently, digital video recorder (DVR) devices, allow end users to record feature content for subsequent viewing as they desire. Many DVR devices include DVD recorders or burners, which allow end users to store content indefinitely without filling up the DVR recorder storage space, e.g., the DVR hard drive.

Video recording devices increase the value of content channels, such as subscription content channels, as subscribers or other end users can record feature content from such channels using these video recording devices. However, the feature content provided by subscription content channels and many other content distribution means typically does not include the added value content that often is included as part of the DVD package sold directly to the consumer. Moreover, content channels and other content distribution means typically do not provide a suitable means to retrieve or otherwise obtain added value content associated with the provided feature content. Thus, distribution methods that do not include added value content with the feature content may be at a disadvantage in terms of potential sales to purchasing consumers.

### BRIEF DESCRIPTION OF THE DRAWINGS

FIG. 1 is a block diagram of a system for providing added value content associated with feature content to a feature content end user;

FIG. 2 is a block diagram of another system for providing added value content associated with feature content to a feature content end user; and

FIG. 3 is a flow chart of a method for providing added value content associated with feature content to a feature content end user.

### DETAILED DESCRIPTION

In the following description, like reference numerals indicate like components to enhance the understanding of the added value content providing system, apparatus and method through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

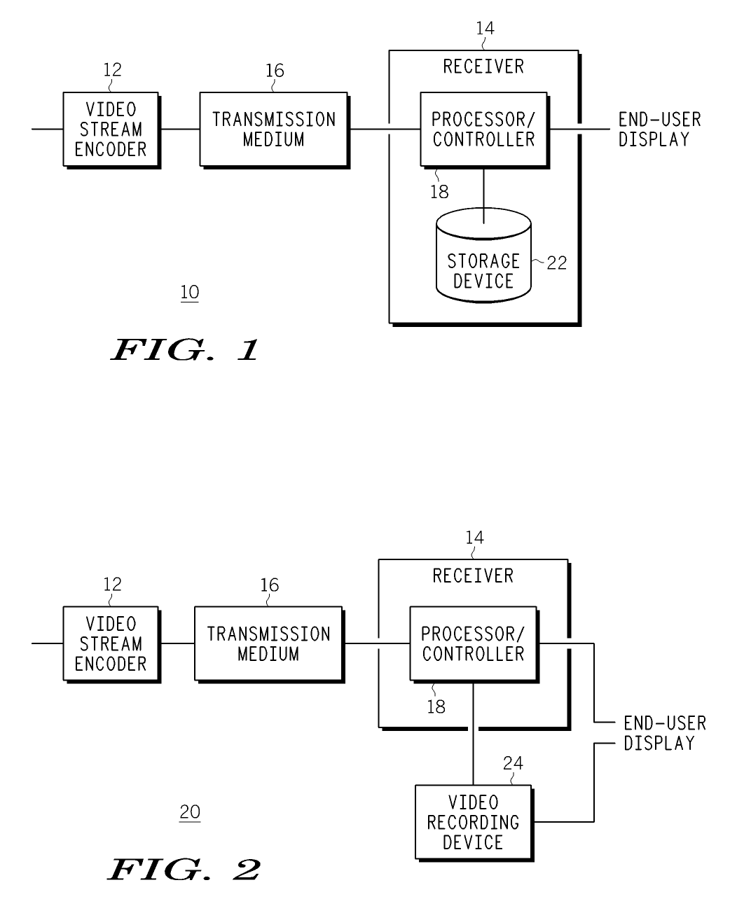

Referring now to FIG. 1, shown is a block diagram of a system 10 for providing added value content to an end user that purchases or otherwise obtains feature content to which the added value content is associated. The system 10 includes an encoder or video stream encoder 12, a receiver or video stream receiver 14, and a transmission medium 16 coupled between the encoder 12 and the receiver 14. The receiver 14 includes a processor or controller 18, and can also include a storage unit or device 22.

The encoder 12 has one or more inputs for receiving feature content from a suitable source. Feature content is content that is broadcast from one or more suitable feature content sources. Feature content sources can include a broadcast programming stream containing premium channel feature content and/or other feature content, a video server or other server containing Video-On-Demand (VOD) content and/or other feature content, and/or other suitable multimedia sources containing feature content. The source typically is located in a headend (not shown) or other suitable location within the system 10. The headend typically is a regional or local hub that is part of a larger service provider distribution system, such as a cable television distribution system.

Feature content includes feature films, programming events, and other multimedia content broadcast to end user subscribers and other end users via premium channel subscriptions and other forms of delivery. As discussed previously, feature content often has associated therewith added value content that sometimes is included with the feature content as a content package made available to consumers, e.g., as a DVD package that can be purchased directly via traditional means of sales.

Feature content received by the encoder 12 that has associated therewith added value content that is to be offered to end users is tagged or encoded, e.g., by the feature content provider, distributor, service provider or other suitable principal in the feature content manufacturing and/or distribution chain. The feature content is tagged in any suitable manner that allows the feature content to be identified by the receiver 14 or other suitable device as feature content that has added value content associated therewith. As will be discussed in greater detail hereinbelow, the added value content can be offered for sale or otherwise provided to an end user who selects the associated feature content for viewing, storing, recording, downloading, or otherwise obtaining.

The feature content is tagged in any suitable manner by any suitable means, e.g., by encoding or embedding metadata in the feature content according to any suitable encoding or embedding technique. Such methods typically are in accordance with various standards, e.g., standards established by the Society of Cable Telecommunications Engineers (SCTE), such as Digital Video Subcommittee (DVS) 629, DVS 630 and DVS 631. For example, in an MPEG (Moving Picture Experts Group) 2 transport stream, the metadata can be embedded in the user_data( ) field.

In general, within the context of video streams and video data, metadata refers to information that describes data in such a way that the data can be catalogued, indexed, archived and/or retrieved at some future date. In the system 10, the encoder 12 embeds or otherwise associates added value content metadata with its associated feature content. In this manner, as will be discussed in greater detail hereinbelow, the added value content metadata can be read by the processor 18 or other suitable portion of the receiver 14 or other suitable device to indicate that added value content exists for the particular feature content. Based on this indication, suitable components in the system 10 can make available to the end user the added value content associated with the feature content. The added value content can be made available for purchase or otherwise provided by any suitable form of delivery, e.g., in the same manner in which the feature content was provided to the end user, or by other suitable form of delivery.

In addition to notifying the existence of added value content associated with particular feature content, the added value content metadata can include other information. For example, the added value content metadata can include what type of added value content that is available. Added value content for some feature content may include only deleted scenes, or only outtakes, while added value content for other feature content may include such added value content and/or additional types of added value content.

Also, the added value content metadata can include information relating to available locations from which to obtain the available added value content. For example, the added value content metadata can include Universal Resource Locators (URLs), which can be used to locate and retrieve added value content associated with particular feature content for delivery to the feature content end user. Also, the added value content metadata can contain digital signature information or similar information for authentication of the added value content.

Also, the added value content metadata can include locators and/or other information relating to available locations from which to obtain additional related metadata and/or additional information about available added value content. Such added value content metadata is particularly useful when the amount and/or type of available added value content changes. For example, the added value content metadata may include a URL for a location that has a database or other means of supplying additional information about available added value content. If the substance and/or nature of the available added value content changes, such information can be updated at the database or other location designated or referenced by the URL, rather than re-encoding the feature content with new added value content metadata. Thus, as additional added value content is made available, the database at the URL is updated, instead of the added value content metadata embedded in the feature content. This is particularly relevant if the feature content is stored on a server, e.g., a VOD server.

Feature content received by the encoder 12 typically is in the form of a multimedia video stream comprised of a plurality of digital video signals formatted according to a suitable standard, such as the MPEG 2 or MPEG 4 standard, and multiplexed into a data stream that is modulated on a carrier using quadrature amplitude modulation (QAM) or other suitable modulation technique. The video stream typically is delivered to the encoder 12 by a digital cable system, such as a Hybrid Fiber Coaxial (HFC) cable system, or other suitable video stream source. The video stream also can be an analog video stream, or an Internet Protocol (IP) video stream transmitted over any suitable Fiber To The Premises (FTTP) system, such as Fiber To The Curb (FTTC) or Fiber To The Home (FTTH), or over any suitable number of digital subscriber line systems (xDSL).

In the system 10, the encoder 12 typically is located at the service provider, i.e., at the location of the source of the video stream. Alternatively, the encoder 12 is located at a location between the service provider and the transmission medium 16. The service provider can be a cable television service provider, a satellite broadcast system service provider, a television service provider (e.g., a national or local television network), an Internet service provider, a telephone service provider, or other suitable service provider.

The encoder 12 can be comprised of any suitable structure or arrangement, e.g., one or more integrated circuits. Also, the encoder 12 can be completely or partially configured in the form of hardware circuitry and/or other hardware components within a larger device or group of components. Alternatively, the encoder 12 is completely or partially configured in the form of software, e.g., as processing instructions or one or more sets of logic or computer code. In such configuration, the logic or processing instructions typically are stored in a data storage device (not shown), which typically is coupled to a processor or controller (not shown). Both the data storage device and the processor or controller can be included as part of the encoder 12, although such is not necessary. The processor accesses the necessary instructions from the data storage device and executes the instructions or transfers the instructions to the appropriate location within the encoder 12.

The encoder 12 includes one or more outputs that are operably coupled to the transmission medium 16. In the system 10, the transmission medium 16 is any suitable transmission medium that can transmit the encoded video streams from the encoder 12 to the receiver 14. For example, the transmission medium 16 can be one or more fiber optic cables, twisted-wire pairs, and/or coaxial cables. Also, the transmission medium 16 can be air, i.e., wireless transmission.

The tagged or encoded video stream transmitted by the encoder 12 to the transmission medium 16 is received from the transmission medium 16 by the receiver 14. As will be understood from additional discussion hereinbelow, the receiver 14 can be part of any suitable device or subsystem (or portion thereof) for processing video signals, such as any digital video recorder (DVR) device, including signal converter or decoder (set-top) boxes with internal and/or external recording capabilities and local and/or remote storage, which often are referred to as personal video recorder (PVR) devices, a residential gateway, or other suitable computing devices or video devices, including internet protocol (IP), satellite and cable digital video recorders, and home area network (HAN) and home media server systems manufactured by Motorola Corp. or other suitable manufacturer.

In general, the receiver 14 receives the encoded video stream from the encoder 12 via the transmission medium 16. The encoded video stream received by the receiver 14 is directed to the processor/controller 18. The video stream information output from the receiver 14 is directed to an end-user display, which can be any suitable display device, such as a television or computer monitor. Any one or more of the components in the receiver 14 can be comprised of any suitable structure or arrangement, e.g., one or more integrated circuits. Also, it should be understood that the receiver 14 includes other components, hardware, and software (not shown) that are used for the normal operation of features and functions of the receiver 14 not specifically described herein.

As discussed, the receiver 14 can have its own recording and/or storage units, e.g., the storage device 22. The storage device 22 is any suitable video stream storage device, such as random access memory (RAM), a magnetic hard disk drive, or optical storage media (e.g., optical disks). Also, although the storage device 22 is shown local to the receiver 14, the storage device 22 can be located external to the receiver 14, e.g., on a separate server or other suitable location that is accessible by the receiver 14.

Alternatively, the receiver 14 can be a video processing device that receives and processes information, and outputs the processed information to another video processing and/or recording device, such as a DVR. For example, in the arrangement of a system 20 shown in FIG. 2, the receiver 14 and its processor 18 is coupled to a video recording device 24. The video recording device 24 is any suitable video recording device, e.g., a DVR. The video recording device 24 is coupled to a suitable end user display device. The output of the receiver 14 also can be coupled to the end user display device.

In general, the processor 18 processes information received by the receiver 14. The processor 18 typically includes at least one type of memory or memory unit (not shown) and a storage unit or data storage unit coupled to the processor for storing processing instructions and information received by the receiver 14. The processor 18 can be completely or partially configured in the form of hardware circuitry and/or other hardware components within a larger device or group of components. Alternatively, the processor 18 can be completely or partially configured in the form of software, e.g., as processing instructions or one or more sets of logic or computer code. In such configuration, the logic or processing instructions typically are stored in the storage unit and/or the memory unit. The processor 18 accesses the necessary instructions and executes the instructions or transfers the instructions to the appropriate location within the receiver 14. Also, as discussed hereinabove, although the storage unit 22 is shown within the receiver 14, the storage unit 22 can be located external to the receiver 14 and suitably coupled thereto.

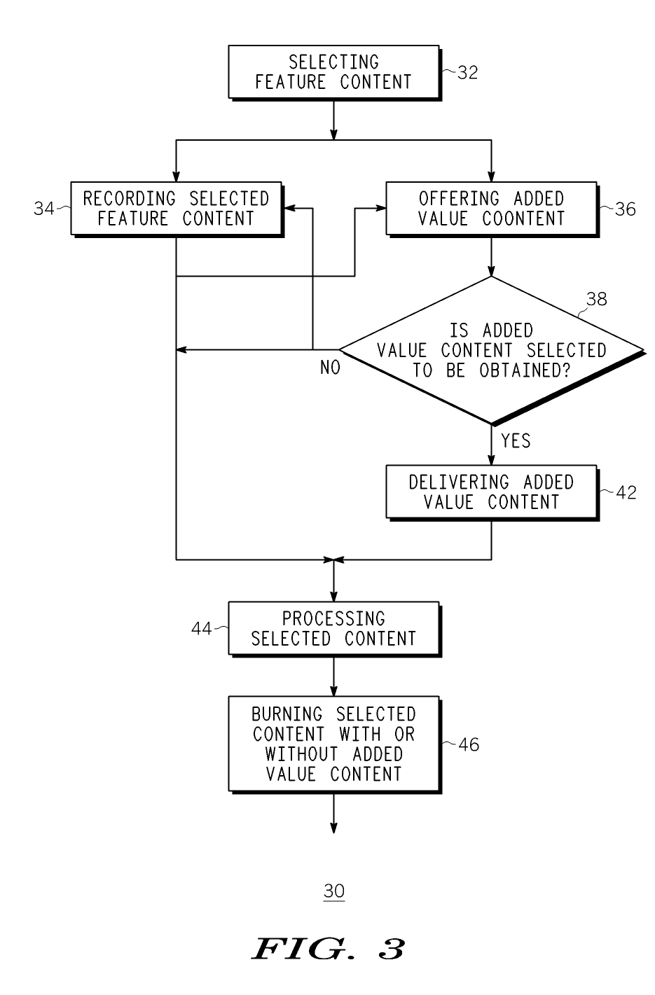

Referring now to FIG. 3, with continuing reference to FIGS. 1 and 2, shown is a flow chart of a method 30 for offering or providing to an end user of feature content available added value content associated with the feature content. The method 30 includes a step 32 of selecting feature content. Once feature content has been tagged, e.g., as discussed hereinabove, the feature content is delivered to the receiver 14 or other appropriate processing device by any suitable means, e.g., by broadcast channel via the transmission medium 16. The delivered feature content may be selected for download, e.g., for real-time or near real-time viewing, and/or recording, e.g., for subsequent viewing or burning to a suitable storage medium.

Feature content is selected by the end user in any suitable manner, e.g., by selecting the title of the feature content via an electronic programming guide used to control the operation of the receiver 14 or other processing device. Alternatively, the feature content can be selected by an agent process running on the receiver 14 or other processing device, e.g., a preference engine that records feature content similar to feature content that previously was selected, or a preference engine that selects feature content that meets certain criteria established by the end user.

The method 30 typically includes a step 34 of recording the selected feature content. As discussed previously herein, the receiver 14 can record the selected feature content to the storage device 22 or to any other suitable recording or storage location, either internal or external to the receiver 14. Alternatively, in the system 20 shown in FIG. 2, the receiver 14 can instruct or otherwise direct the recording device 24 to record the selected feature content.

The method 30 includes a step 36 of providing or offering available added value content that is associated with the selected feature content. As discussed hereinabove, certain feature films, special programming events and/or other feature content has associated therewith available added value content. As feature content is received by the receiver 14 and the processor 18, the processor 18 examines the feature content video stream and reads and/or decodes any embedded added value content metadata for information regarding available added value content associated with the received feature content.

The processor 18 and/or other suitable portions of the receiver 14 include decoding software and/or hardware configured to read added value content metadata. The processor 18 can examine the video stream in real-time, i.e., as the video stream is passing through the processor 18 and other components in the receiver 14. Alternatively, the processor 18 can examine the video stream after portions of the video stream have been buffered, recorded or otherwise stored.

Based on the added value content metadata read by the processor 18 or other suitable device, added value content associated with the selected feature content is made available to the end user. As shown in FIG. 3, the step 36 of offering added value content can be performed after the feature content selecting step 32 (i.e., before the recording step 34), and/or after the recording step 34. Also, it should be understood that the offering step 36 also can be performed during the recording step 34, i.e., as the selected feature content is being recorded.

The added value content can be offered to the end user in any suitable manner. For example, the added value content metadata of selected feature content may contain information suitable to direct the processor 18 (e.g., via a receiver interface) to an external location of an advertisement for the added value content. The external location can be, e.g., an online store accessible by the receiver 14. The advertisement can be delivered to the receiver 14 for processing and for subsequent viewing, e.g., by the end user display.

Alternatively, the advertisement for the added value content can be included as an encoded portion of the feature content. In such case, the processor 18, upon reading the added value content metadata, accesses the advertisement from the feature content. The advertisement can describe and include the nature of the added value content, and whether there is a cost associated with acquiring the added value content or whether the added value content can be acquired without charge.

Upon viewing the advertisement, the end user can select whether or not to obtain the added value content associated with the selected feature content. Such decision is shown in FIG. 3 as a decision block or function block 38. If the end user chooses to obtain the added value content, a step 42 of delivering the added value content is performed. For example, if the end user chooses to obtain the added value content, the end user may be prompted to provide billing information for the purchase of the added value content via a secured transaction. Alternatively, the end user may be prompted to provide existing account information for billing of the added value content thereto.

In addition to the added value content described hereinabove, the added value content also may include additional content, such as one or more navigators, e.g., a features navigator and/or a scenes navigator. Also, additional added value content can include scenes that previously were deleted for broadcast, replacement audio and/or video that previously may have been censored (e.g., blurred and/or bleeped) for broadcast. Also, the additional added value content can include other related audio and/or video, e.g., games related to the feature content.

Moreover, the added value content can include processing instructions for creating the final content, i.e., the feature content plus added value content. Also, the added value content can include labeling (jewel case artwork) and/or image information, e.g., for the final processing and packaging of the added value content with the feature content, as will be discussed in greater detail hereinbelow.

Once the end user has provided the necessary information or otherwise has been approved or authorized to receive the added value content, the added value content is delivered to the end user. For example, in the system 10 shown in FIG. 1, the added value content is downloaded to the receiver 14 from the encoder 12 via the transmission medium 16, and stored, e.g., temporarily, in the storage device 22. Alternatively, in the system 20 shown in FIG. 2, the added value content is downloaded to the receiver 14 from the encoder 12 via the transmission medium 16, and the receiver 14 passes the downloaded added value content to the video recording device 24, for storage therein.

Referring again to the decision or function block 38, if the end user chooses not to obtain the added value content, the method 30 returns to the portion of the method 30 that was being performed just before the offering step 36, as shown in FIG. 3. That is, if the offering step 36 was performed prior to the feature content recording step 34 and the end user chose not to obtain the added value content, the method 30 returns to the point in the method 30 prior to the recording step 34. If the offering step 36 was performed after the recording step 34 and the end user chose not to obtain the added value content, the method 30 returns to the point in the method 30 after the recording step 34.

Once the selected feature content recording step 34 and/or the added value content delivering step 42 have been performed, the method 30 performs a step 44 of processing the selected content. As discussed hereinabove, the selected content includes the selected feature content, and also may include added value content, if the end user chose to obtain the added value content. If the end user did not choose to obtain the added value content, the selected content will not include added value content.

The processing step 44 can include performing a number of tasks that may be needed to create the final product of content selected by the end user. The processing step 44 may include checking the integrity of the delivered content, including both the feature content and, if chosen, the added value content. For example, if a portion of either the feature content or the added value content was inadvertently missing or corrupted from its initial download, the processing step 44 can have that portion of the content retrieved again or re-downloaded, e.g., from the server or other location that provided the content during its initial acquisition.

Similarly, the processing step 44 may include error correction and/or encryption functions, as needed. Also, the processing step 44 may include removing advertisements or other content and/or information that is not part of the core or base feature content or the added value content. The processing step 44 also can include restoring censored or edited content, re-indexing feature content and/or added value content to match the scene navigation, or changing digital rights management tags, e.g., for end users that purchase the added value content.

The method 30 includes a step 46 of burning or recording the selected content, with or without its associated added value content, to a suitable content storage medium. Once the processing step 44 has been completed and the total package of processed content is created and obtained, the content is available in its final format and is ready to be burned or recorded to a suitable content storage medium. The step 46 burns the final assembled content to a suitable storage medium, e.g., a DVD, an optical disk, or a (removable) memory card.

The method shown in FIG. 3 may be implemented in a general, multi-purpose or single purpose processor. Such a processor will execute instructions, either at the assembly, compiled or machine-level, to perform that process. Those instructions can be written by one of ordinary skill in the art following the description of FIG. 3 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the added value content providing system, apparatus and method herein described without departing from the spirit and scope of the invention as defined by the appended claims and their full scope of equivalents.

1. A computer program embodied in a computer-readable medium for offering added value content associated with feature content, wherein the feature content has added value content metadata associated therewith, the program comprising:
instructions for reading the added value content metadata associated with feature content obtained by an end user;
instructions for offering, in response to reading the added value content metadata, to the end user at least a portion of the added value content associated with the feature content; and
wherein the added value content is associated with but not part of the feature content.

2. The computer program as recited in claim 1, wherein the offering instructions further comprise offering the end user added value content associated with the feature content in response to reading the added value content metadata and in response to at least one recording device recording the feature content.

3. The computer program as recited in claim 1, wherein the offering instructions include instructions for purchasing the added value content.

4. The computer program as recited in claim 1, wherein the offering instructions further comprise providing an advertisement for the added value content.

5. The computer program as recited in claim 1, wherein the added value content metadata includes information relating to a location that includes information about available added value content, and wherein the offering instructions further comprise instructions for accessing the information about available added value content from the location in response to reading the added value content metadata.

6. The computer program as recited in claim 1, further comprising instructions for recording on a recording device at least a portion of the added value content.

7. The computer program as recited in claim 1, further comprising instructions for requesting the feature content from a Video-On-Demand system.

8. The computer program as recited in claim 1, further comprising instructions for tuning the feature content from a broadcast system.

9. The computer program as recited in claim 8, wherein the processing instructions further comprise processing at least one of feature content and added value content associated with the feature content.

10. The computer program as recited in claim 1, wherein the added value content metadata is embedded into the feature content.

11. An apparatus for providing added value content associated with feature content, wherein the feature content has added value content metadata associated therewith, the apparatus comprising:
a processor configured for reading added value content metadata associated with feature content obtained by an end user, and, in response to reading the added value content metadata, providing to the end user the ability to obtain at least a portion of the added value content associated with the feature content wherein the added value content is associated with but not part of the feature content.

12. The apparatus as recited in claim 11, wherein the processor is configured to provide to the end user instructions for purchasing the added value content.

13. The apparatus as recited in claim 11, wherein the processor is configured to provide to the end user an advertisement for the added value content.

14. The apparatus as recited in claim 11, wherein the apparatus further comprises a storage unit coupled to the processor, and wherein the processor is configured to record in the storage unit at least one of at least a portion of the feature content and at least a portion of the added value content.

15. The apparatus as recited in claim 11, wherein the processor is configured to process at least one of at least a portion of the feature content and at least a portion of the added value content obtained by the end user.

16. The apparatus as recited in claim 11, wherein at least a portion of the processor is implemented in software executed by a computer.

17. The apparatus as recited in claim 11, wherein at least a portion of the processor is implemented in hardware.

18. The apparatus as recited in claim 11, wherein at least a portion of the apparatus is contained in a video processing device.

19. The apparatus as recited in claim 18, wherein the video processing device is selected from the group consisting of a signal converter box, a signal decoder box, a digital video disk recorder, a personal video recorder device, a home media server, and a computer.

20. The apparatus as recited in claim 11, wherein at least a portion of the apparatus further comprises an integrated circuit.
